(19) United States
(12) Patent Application Publication
(10) Pub. No.: US 2026/0034965 A1
(43) Pub. Date: Feb. 5, 2026

(54) SYSTEMS AND METHODS FOR PREDICTING WINDSHIELD WIPER WEAR

(71) Applicants: Hyundai Motor Company, Seoul (KR); Kia Corporation, Seoul (KR)

(72) Inventors: Matthew C. Glaze, Superior Township, MI (US); Angelo Dilisio, Ann Arbor, MI (US)

(21) Appl. No.: 18/789,260

(22) Filed: Jul. 30, 2024

(51) Int. Cl. B60S 1/38

(52) U.S. Cl. CPC B60S 1/38; B60S 2001/3844

(57) ABSTRACT

Systems and methods for predicting windshield wiper wear are provided. The system may comprise a vehicle comprising a windshield wiper. The windshield wiper may comprise a windshield wiper blade. The system may comprise one or more environmental sensors configured to generate environmental data of an environment of the vehicle, and a computing device. The computing device may comprise a processor and a memory. The memory may be configured to store instructions that, when executed by the processor, are configured to cause the processor to receive the environmental data from the one or more environmental sensors and calculate wear of the windshield wiper blade based on the environmental data.

### BACKGROUND

### Technical Field

Embodiments of the present disclosure relate to systems and methods for predicting windshield wiper wear and, in particular, to systems and methods for predicting windshield wiper wear due to environmental conditions and extended non-use.

### Background

The rubber in windshield wipers can be deteriorated by environmental conditions (e.g., temperature, rain, sunshine, etc.) and lack of use (where windshield wipers press against the windshield). This deterioration causes the blade portion of a windshield wiper to separate or tear away from the support arm when the windshield wiper is turned on. This separated blade portion prevents the windshield wiper from correctly functioning, and a non-functioning windshield wiper will not clear rain, moisture, or other debris from the windshield.

An unwiped windshield greatly reduces visibility during heavy rain. Given the lack of visibility through the windshield, it can be extremely dangerous to drive in heavy rain without functional windshield wipers. In the case of severe rain, the driver may have no choice but to pull over and wait until the rain stops. In the case of autonomous vehicles (AVs), with low visibility. the AV may need to stop and wait for repair.

Windshield wiper deterioration poses a serious problem in areas where annual rainfall is low (e.g., the United States southwest and west). In places with low annual rainfall, windshield wipers might not be used for months and, since lack of use can cause windshield wiper deterioration, the windshield wipers may have deteriorated without the driver knowing. The driver may not know that the windshield wipers have deteriorated until the windshield wipers are used during the first rain. However, by this time, it is too late to fix the windshield wipers before they are needed, causing a dangerous situation, since the driver is surprised by non-functional windshield wipers at a most critical time of need for the windshield wipers.

While there are systems and methods for protecting windshield wipers, such as, e.g., systems and methods for covering or hiding the windshield wipers, these pose disadvantages. For example, covering windshield wipers restricts the design of the windshield wipers, increases costs, and poses packaging issues.

For at least these reasons, systems and methods for predicting windshield wiper wear due to environmental conditions and extended non-use are needed.

### SUMMARY

According to an object of the present disclosure, a system for predicting windshield wiper wear is provided. The system may comprise a vehicle comprising a windshield wiper. The windshield wiper may comprise a windshield wiper blade. The system may comprise one or more environmental sensors configured to generate environmental data of an environment of the vehicle, and a computing device. The computing device may comprise a processor and a memory. The memory may be configured to store instructions that, when executed by the processor, are configured to cause the processor to receive the environmental data from the one or more environmental sensors, and calculate wear of the windshield wiper blade based on the environmental data.

According to an exemplary embodiment, the instructions, when executed by the processor, may be further configured to cause the processor to determine a usage of the windshield wiper comprising a length of time the windshield wiper was in an on state over a set timeframe.

According to an exemplary embodiment, the instructions, when executed by the processor, may be further configured to cause the processor to adjust the wear of the windshield wiper blade due to the usage of the windshield wiper, generating an adjusted wear of the windshield wiper blade, determine whether the adjusted wear of the windshield wiper blade is greater than a threshold wear, and, when the adjusted wear of the windshield wiper blade is greater than the threshold wear, generate a warning alert.

According to an exemplary embodiment. the adjusting the wear of the windshield wiper blade may comprise determining a windshield wiper blade use factor and multiplying the wear of the windshield wiper blade by the windshield wiper blade user factor.

According to an exemplary embodiment, the computing device may further comprise a graphical user interface.

According to an exemplary embodiment, the instructions, when executed by the processor, may be further configured to cause the processor to play the warning alert on the graphical user interface.

According to an exemplary embodiment, the warning alert may comprise an audio and/or visual alert.

According to an exemplary embodiment, the one or more environmental sensors may comprise one or more of: a temperature sensor; a rainfall sensor; and a solar load sensor.

According to an exemplary embodiment, the temperature sensor may be configured to measure an outside air temperature and collect data to be used to estimate one or more heat cycles the windshield wiper blades.

According to an exemplary embodiment, the rainfall sensor may be configured to collect data to be used to estimate how much rain the windshield wiper blades have been exposed to.

According to an exemplary embodiment, the solar load sensor may be configured to collect data to be used to determine how much sunlight the windshield wiper blades have been exposed to.

According to an exemplary embodiment, the vehicle may comprise an autonomous vehicle.

According to an object of the present disclosure, a method for predicting windshield wiper wear is provided. The method may comprise generating, using one or more environmental sensors, environmental data of an environment of a vehicle. The vehicle may comprise a windshield wiper. The windshield wiper may comprise a windshield wiper blade. The method may comprise, using a computing device, receiving the environmental data from the one or more environmental sensors and calculating wear of the windshield wiper blade based on the environmental data. The computing device may comprise a processor and a memory.

According to an exemplary embodiment, the method may further comprise, using the computing device, determining a usage of the windshield wiper comprising a length of time the windshield wiper was in an on state over a set timeframe.

According to an exemplary embodiment, the method may further comprise adjusting the wear of the windshield wiper blade due to the usage of the windshield wiper, generating an adjusted wear of the windshield wiper blade, determining whether the adjusted wear of the windshield wiper blade is greater than a threshold wear, and, when the adjusted wear of the windshield wiper blade is greater than the threshold wear, generating a warning alert.

According to an exemplary embodiment, the adjusting the wear of the windshield wiper blade may comprise determining a windshield wiper blade use factor and multiplying the wear of the windshield wiper blade by the windshield wiper blade user factor.

According to an exemplary embodiment, the computing device may comprise a graphical user interface.

According to an exemplary embodiment, the method may further comprise, using the computing device, causing the processor to play the warning alert on the graphical user interface, wherein the warning alert comprises an audio and/or visual alert.

According to an exemplary embodiment, the one or more environmental sensors may comprise one or more of: a temperature sensor; a rainfall sensor; and a solar load sensor.

According to an exemplary embodiment, the temperature sensor may be configured to measure an outside air temperature and collect data to be used to estimate one or more heat cycles the windshield wiper blades.

According to an exemplary embodiment, the rainfall sensor may be configured to collect data to be used to estimate how much rain the windshield wiper blades have been exposed to.

According to an exemplary embodiment, the solar load sensor may be configured to collect data to be used to determine how much sunlight the windshield wiper blades have been exposed to.

According to an exemplary embodiment, the vehicle may comprise an autonomous vehicle.

### BRIEF DESCRIPTION OF THE DRAWINGS

The accompanying drawings, which are incorporated in and form a part of the Detailed Description, illustrate various non-limiting and non-exhaustive embodiments of the subject matter and, together with the Detailed Description, serve to explain principles of the subject matter discussed below. Unless specifically noted, the drawings referred to in this Brief Description of Drawings should be understood as not being drawn to scale and like reference numerals refer to like parts throughout the various figures unless otherwise specified.

FIG. 1A illustrates a vehicle configured for predicting windshield wiper wear due to environmental conditions and extended non-use, according to an exemplary embodiment of the present disclosure.

FIG. 1B illustrates a system comprising one or more environmental sensors and one or more computing devices configured for predicting windshield wiper wear due to environmental conditions and extended non-use, according to an exemplary embodiment of the present disclosure.

FIGS. 2A-2C illustrate a flowchart of a method for predicting windshield wiper wear due to environmental conditions and extended non-use, according to an exemplary embodiment of the present disclosure.

FIG. 3 illustrates an example architecture of a vehicle, according to an exemplary embodiment of the present disclosure.

FIG. 4 illustrates example elements of a computing device, according to an exemplary embodiment of the present disclosure.

### DETAILED DESCRIPTION

The following Detailed Description is merely provided by way of example and not of limitation. Furthermore, there is no intention to be bound by any expressed or implied theory presented in the preceding background or in the following Detailed Description.

Reference will now be made in detail to various exemplary embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications, and equivalents, which may be included within the spirit and scope of the various embodiments as defined by the appended claims. Furthermore, in this Detailed Description, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

Some portions of the detailed descriptions which follow are presented in terms of procedures, logic blocks, processing, and other symbolic representations of operations on data within an electrical device. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities may take the form of electrical or magnetic signals capable of being stored, transferred, combined, compared, and otherwise manipulated in an electronic system, device, and/or component.

It should be borne in mind, however, that these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “determining,” “communicating,” “taking.” “comparing,” “monitoring,” “calibrating,” “estimating.” “initiating,” “providing,” “receiving,” “controlling,” “transmitting,” “isolating,” “generating,” “aligning,” “synchronizing,” “identifying,” “maintaining,” “displaying,” “switching,” or the like, refer to the actions and processes of an electronic item such as: a processor, a sensor processing unit (SPU), a processor of a sensor processing unit, an application processor of an electronic device/system, or the like, or a combination thereof. The item manipulates and transforms data represented as physical (electronic and/or magnetic) quantities within the registers and memories into other data similarly represented as physical quantities within memories or registers or other such information storage, transmission, processing, or display components.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles. In aspects, a vehicle may comprise an internal combustion engine system as disclosed herein.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes. floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.19%, 0.05%, or 0.01% of the stated value. Unless otherwise clear from the context, all numerical values provided herein are modified by the term “about”.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, logic, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example device vibration sensing system and/or electronic device described herein may include components other than those shown, including well-known components.

Various techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

Various embodiments described herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), a programmable logic controller (PLC), a complex programmable logic device (CPLD), a discrete gate or transistor logic, discrete hardware components, or any combination thereof designed to perform the functions described herein, or other equivalent integrated or discrete logic circuitry. The term “processor,” as used herein may refer to any of the foregoing structures or any other structure suitable for implementation of the techniques described herein. As employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Moreover, processors can exploit nano-scale architectures such as, but not limited to, molecular and quantum-dot based transistors, switches and gates, in order to optimize space usage or enhance performance of user equipment. A processor may also be implemented as a combination of computing processing units.

In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration. One or more components of an SPU or electronic device described herein may be embodied in the form of one or more of a “chip,” a “package,” an Integrated Circuit (IC).

According to exemplary embodiments, systems and methods for predicting windshield wiper wear due to environmental conditions and extended non-use are provided.

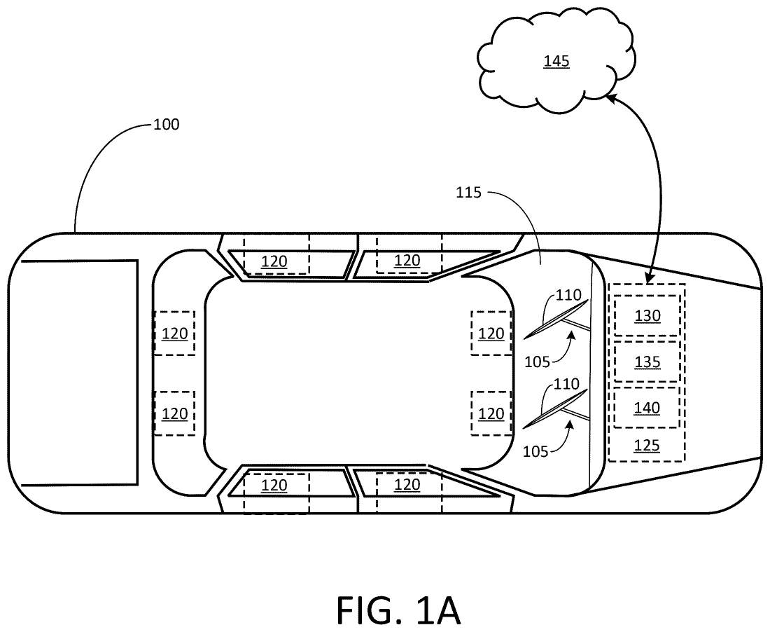

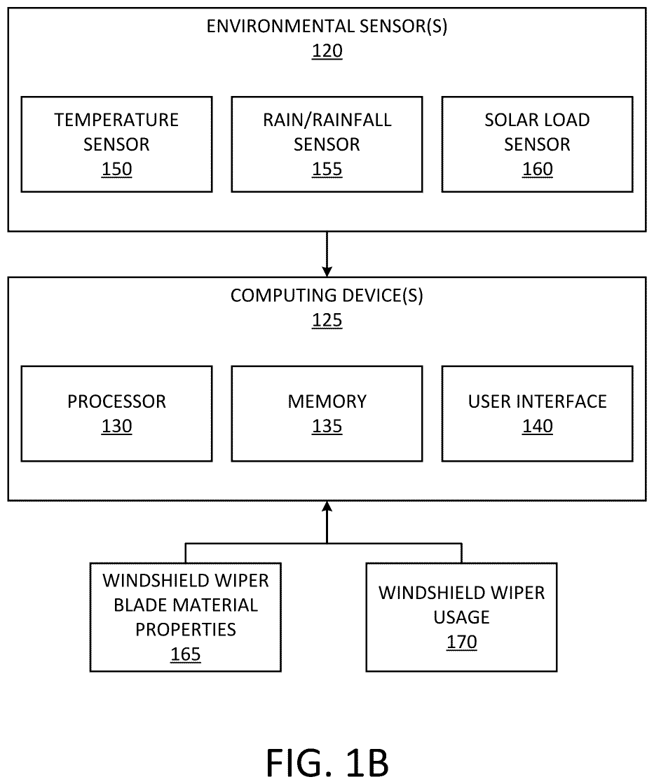

Referring now to FIGS. 1A-1B, a vehicle 100 (FIG. 1A) configured for predicting windshield wiper 105 wear due to environmental conditions and extended non-use, and a system comprising one or more environmental sensors 120 and one or more computing devices 125 configured for predicting windshield wiper wear due to environmental conditions and extended non-use are illustratively depicted, in accordance with an exemplary embodiment of the present disclosure. According to an exemplary embodiment, the vehicle 100 may comprise an electric vehicle, autonomous vehicle, and/or other suitable vehicle. It is noted that, while the vehicle 100 is illustrated as an automobile, the vehicle may comprise other vehicles such as, e.g., buses, trains, planes, boats, and/or other suitable vehicles.

According to an exemplary embodiment, the vehicle 100 may comprise one or more windshield wipers 105 and/or one or more windshields 115. Each windshield wiper 105 may comprise a windshield wiper blade 110 configured to contact the windshield 115 and remove water, ice, and/or other debris off of all or a portion of the windshield 115. The windshield wiper blade 110 may comprise rubber and/or other suitable material.

According to an exemplary embodiment, the vehicle 100 may comprise one or more environmental sensors 120 such as, e.g., one or more temperature sensors 150. precipitation (rain/rainfall) sensors 155, solar load (light) sensors 160, humidity sensors, and/or other suitable environmental sensors. The one or more environmental sensors 120 may be configured to generate environmental data pertaining to an environment of the vehicle 100 such as, e.g., temperature data, rain data (e.g., rain amount, duration, etc.), solar load data, and/or other suitable environmental data.

According to an exemplary embodiment, the vehicle 100 may comprise one or more computing devices 125. According to an exemplary embodiment, each of the one or more computing devices 125 may comprise a processor 130, a memory 135, and/or a user interface 140 (e.g., a graphical user interface including a display (e.g., a driver display, a passenger display, and/or other suitable display), a microphone, a speaker, and/or other suitable components). The computing device 125 may be configured to send and/or receive commands/data/etc. via one or more external systems via wired and/or wireless connection (e.g., via the cloud 145). The memory 135 may be configured to store programming instructions that, when executed by the processor 130. may be configured to cause the processor 130 to perform one or more tasks such as, e.g., receiving cumulative environmental data from the one or more environmental sensors 120, calculating windshield wiper blade 110 wear, adjusting windshield wiper blade 110 wear for windshield wiper 105 usage, determining whether windshield wiper blade 110 wear is greater than a threshold, generating a warning alert for windshield wiper blade 110 wear, and/or performing one or more other suitable tasks.

According to an exemplary embodiment, the one or more temperature sensors 150 may be configured to measure an outside air temperature and collect data that may be used to estimate the heat cycles the windshield wiper blades have been exposed to.

According to an exemplary embodiment, the one or more rain/rainfall sensors 155 may be configured to collect data that may be used to estimate how much rain the windshield wiper blades have been exposed to.

According to an exemplary embodiment, the one or more solar load sensors 160 may be configured to collect data that may be used to determine how long the vehicle 100 has been in sunlight and how much sunlight the car and windshield wiper blades have been exposed to.

According to an exemplary embodiment, one or more windshield wiper blade 110 material properties 165 may be input into the one or more computing devices 125. According to an exemplary embodiment, determining how long the windshield wiper blades 110 will last for a given exposure to sunlight may be determined through experimentation or estimated by design and may be directly related to the material properties.

According to an exemplary embodiment, the windshield wiper 105 usage 170 (e.g., data collected when the windshield wipers 105 are turned on) may be input into the one or more computing devices 125. According to an exemplary embodiment, the windshield wiper 105 usage 170 may equate to the length of time the windshield wipers 105 were in an on state over a set timeframe. According to an exemplary embodiment, the windshield wiper 105 usage may be provided by an electronic control unit (ECU) for a windshield wiper blade 110 system. According to an exemplary embodiment, the windshield wiper 105 usage data 170 may be used to estimate whether a driver has checked the windshield wiper blades.

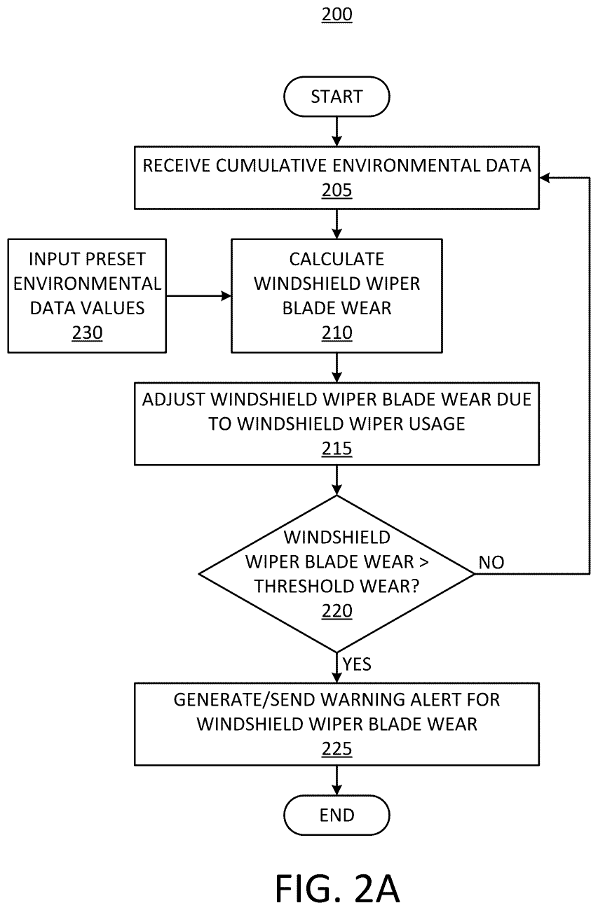

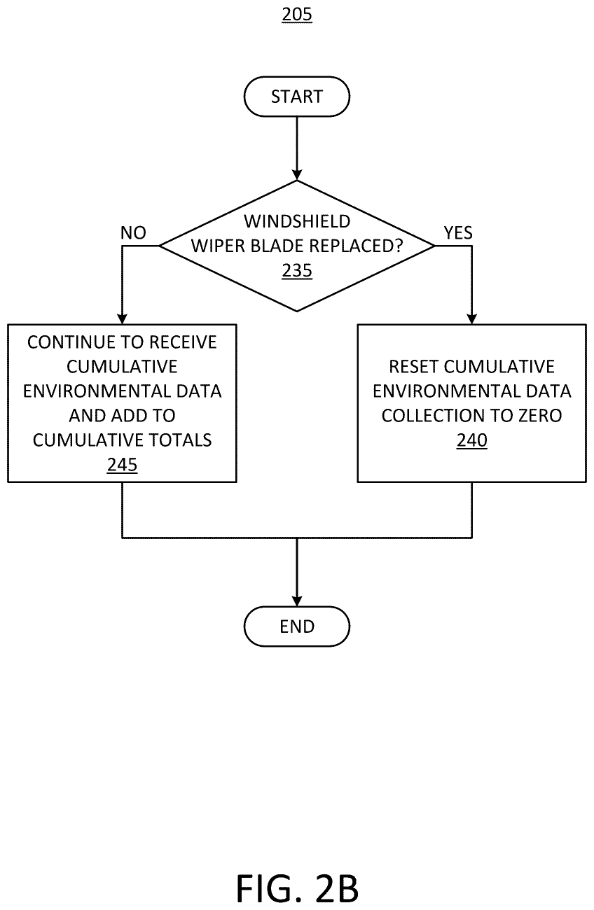

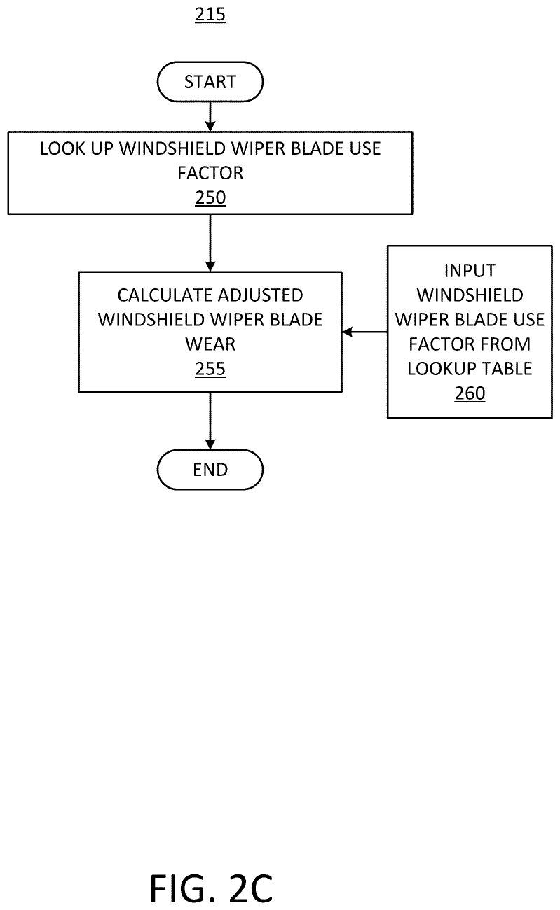

Referring now to FIGS. 2A-2C, flowchart of a method 200 for predicting windshield wiper wear due to environmental conditions and extended non-use is illustratively depicted, in accordance with an exemplary embodiment of the present disclosure.

At 205, environmental condition data may be received from one or more environmental sensors of the vehicle. According to an exemplary embodiment, the environmental data may be received, stored, and used cumulatively from the last new wiper blade installation. According to an exemplary embodiment, receiving the environmental condition data may comprise, at 235, determining whether a windshield wiper blade has been replaced. New windshield wiper blades produce more friction as there is more contact surface compared to torn windshield wiper blades. The higher friction would require more electrical current to the motors. The electrical current usage may be used to determine whether the windshield wiper blades have been changed. It is noted, however, that other suitable means/methods for determining whether the windshield wiper blades have been changed (e.g., manual input, visual analysis, etc.) may be incorporated while maintaining the spirit and functionality of the present disclosure.

When the windshield wiper blade has been replaced, then, at 240, the cumulative environmental data collection may be reset to zero. When the windshield wiper blade has not been replaced, the, at 245, cumulative environmental data may be received and added to the cumulative totals.

At 210, windshield wiper blade wear may be calculated. According to an exemplary embodiment, estimated windshield wiper blade wear may be calculated in hours. It is noted, however, that other means for calculating windshield wiper blade wear may be incorporated while maintaining the spirit and functionality of the present disclosure.

According to an exemplary embodiment, wear from individual environmental conditions may be evaluated as an environmental data cumulative value multiplied by a wear factor, where data may be collected cumulatively from a new windshield wiper installation. According to an exemplary embodiment, the windshield wiper blade wear value may equal a maximum value of individually calculated wear values, as shown, e.g., in Equation 1.

$$Windshield Wiper Blade Wear = Max [ ( Environmental Data {Value}_{1} ) \times ( Wear {Factor}_{1} ) , … , ( Environmental Data {Factor}_{n} \times Wear {Factor}_{n} ) ] \qquad Equation 1$$

According to an alternative exemplary embodiment, multiple environmental data values may be combined and then multiplied by single wear factor that accounts for multiple environmental conditions.

Examples of environmental data values may comprise, but are not limited to, temperature data values (e.g., average high temperature, average cold temperature, average daily temperature differential, etc.), rain/rainfall data values (e.g., cumulative rainfall, etc.), and solar load data values. According to an exemplary embodiment, the environmental data values may be provided/collected/generated by the one or more environmental sensors of the vehicle. According to an exemplary embodiment, the environmental data values may be received and recorded cumulatively, starting when a new windshield wiper blade (or a plurality of windshield wiper blades) is installed.

Windshield wiper blades are made from known material(s) (e.g., rubber) with known material properties. According to an exemplary embodiment, wear factors for different environmental data values may be calculated for a windshield wiper blade's expected rate of structural degradation/loss of strength due to environmental exposure.

Wear factors may be calculated and preset for a system. Wear factors may be updated by over-the-air update or system service and/or other suitable systems and/or services. According to an exemplary embodiment, at 230, preset environmental data values may be input and used in calculating the windshield wiper blade wear.

By way of example, the environmental data values may comprise a temperature data value, a rainfall data value, and a solar load data value, and the wear factors may comprise a temperature wear factor, a rainfall wear factor, and a solar load wear factor, as shown, e.g., in Equation 2.

$$Windshield Wiper Blade Wear = Max [ ( Temperature Data Value \times Temperature Wear Factor ) , ( Rainfall Data Value \times Rainfall Wear Factor ) , ( Solar Load Data Factor \times Solar Load Wear Factor ) ] \qquad Equation 2$$

By way of example, the temperature data value may equal 60 Days>40° C., the temperature wear factor may equal

$$30 \frac{hours wear}{day > 40 ° C .} ,$$

the rainfall data value may equal 100 days≤10 mm rain, the rainfall wear factor may equal

$$15 \frac{hours wear}{days with \leq 10 mm rain} ,$$

the solar load data value may equal

$$20 \frac{W}{{m}^{2}} ,$$

and the solar load wear factor may equal

$$25 \frac{hours wear}{\frac{W}{{m}^{2}}}$$

The windshield wiper blade wear may then be calculated as:

$$\begin{matrix}Windshield Wiper Blade Wear = Max [ ( 60 Days > 40 ° C . \times 30 \frac{hours wear}{day > 40 ° C .} ) , ( 100 days \leq 10 mm rain \times 15 \frac{hours wear}{days with \leq 10 mm rain} ) , \\ ( 20 \frac{W}{{m}^{2}} \times 25 \frac{hours wear}{\frac{W}{{m}^{2}}} ) ] \\ = Max [ ( 1 , 800 hours ) , ( 1 , 500 hours ) , ( 500 hours ) ] \\ = 1 , 800 hours\end{matrix}$$

As illustrated, temperature, rainfall, and solar load are each considered individually. Alternatively, the compounding effect of combined environmental values may be considered with corresponding wear factors for compounded environmental data values. Since 1,800 hours is the maximum value of the individually calculated wear values, the windshield wiper blade wear value is calculated to be 1,800 hours. It is noted, however, that these values are non-limiting examples for environmental data values and wear factors. Alternatively, temperature data may be defined as average daily temperature differential or average high temperature. Alternatively, rainfall wear may be calculated as inverse of measured rainfall (e.g., less measured rainfall, more wear).

At 215, the estimated wear due to non-usage of windshield wiper blades may be adjusted.

When not in use, windshield wiper blades press against the windshield. This pressure results in additional wear on the wiper blades from compression set. Pressing against the windshield adds stress and increases structural degradation of the windshield wiper blades

According to an exemplary embodiment, adjusted windshield wiper blade wear may be calculated as the product of the windshield wiper blade wear and the windshield wiper blade use factor, as shown in Equation 3. According to an exemplary embodiment, the windshield wiper blade use factor may be acquired from a look-up table. It is noted, however, that other suitable means for calculating the windshield wiper blade use factor may be incorporated while maintaining the spirit and use of the present disclosure.

$$Adjusted Windshield Wiper Blade Wear = ( Windshield Wiper Blade Wear ) \times ( Windshield Wiper Blade Use Factor ) \qquad Equation 3$$

According to an exemplary embodiment, adjusting the estimated wear due to non-usage of windshield wiper blades may comprise, at 250, looking up the windshield wiper blade use factor and, at 255, calculating the adjusted windshield wiper blade wear using the windshield wiper blade use factor that may be input, at 260. The windshield wiper blade use factor may be calculated because windshield wiper blades are generally made from known material (e.g., rubber) with known material properties.

According to an exemplary embodiment, the windshield wiper blade use factor may be looked up as a function of the longest time period that the windshield wiper blade was not used (as shown, e.g., in Table 1). It is noted, however, that other means/methods for looking up the windshield wiper blade use factor may be incorporated while maintaining the spirit and functionality of the present disclosure. For example, the windshield wiper blade use factor may be calculated from an average time period between wiper blade usage.

TABLE 1

| Longest Time Period (hours) that the | Windshield Wiper Blade |
|---|---|
| Windshield Wiper Blade was Not Used | Adjustment Factor |
| <500 | 1.00 |
| 1,000 | 1.02 |
| 1,500 | 1.07 |
| 2,000 | 1.15 |
| 2,500 | 1.27 |
| >2,500 | 1.50 |

It is noted that the values present in Table 1 are illustrative, not limiting, and presented by way of example. Other values may be used while maintaining the spirit and functionality of the present disclosure.

At 220, it may be determined whether the adjusted windshield wiper blade wear is greater than a wear threshold. According to an exemplary embodiment, when the adjusted windshield wiper blade wear is greater than the wear threshold, then, at 225, a windshield wiper blade wear warning alert may be generated and sent to notify a user about windshield wiper blade ware. According to an exemplary embodiment, sending the windshield wiper blade warning alert may comprise playing the windshield wiper blade warning alert on the graphical user interface. The warning alert may be a visual and/or audio warning to the driver. According to an exemplary embodiment, in the case of an autonomous or fleet vehicle, the warning alert may be issued to a fleet manager. According to an exemplary embodiment, the system may be configured to perform artificial intelligence, machine learning, and/or other suitable means in order to more accurately determine when the windshield wiper blades may fail through repeated resets and windshield wiper blade replacements.

According to an exemplary embodiment, after the warning alert has been sent, a timer may begin before the warning alert is sent again, if the windshield wiper blades are not replaced.

According to an exemplary embodiment, when the adjusted windshield wiper blade wear is not greater than the wear threshold, then, at 205, environmental data continues to be received and, at 210, the windshield wiper blade wear is calculated.

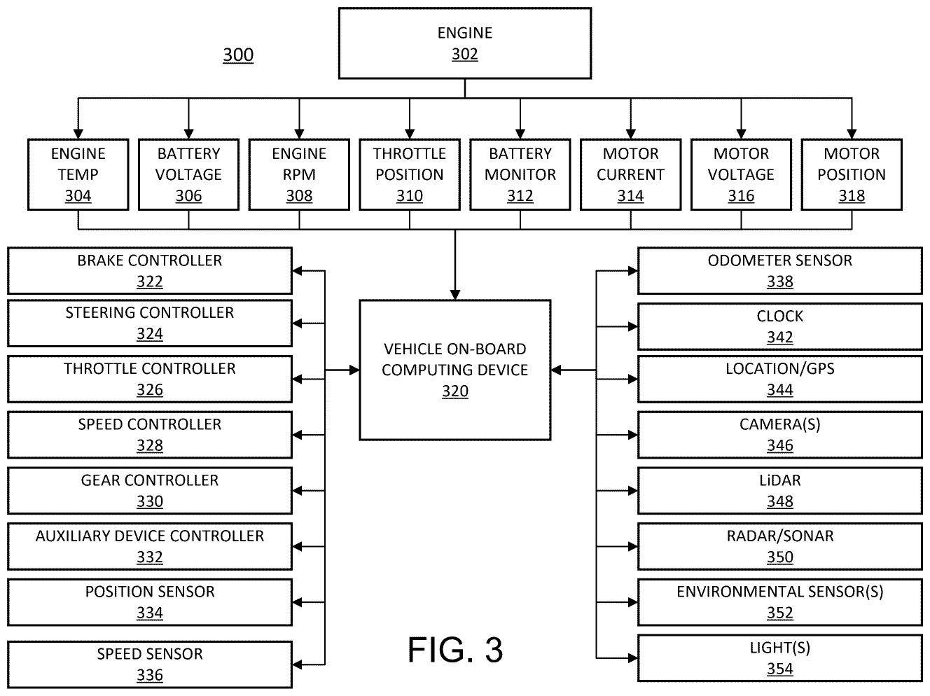

Referring now to FIG. 3, an example vehicle system architecture 300 for a vehicle is provided, in accordance with an exemplary embodiment of the present disclosure. The following discussion of vehicle system architecture 300 is sufficient for understanding one or more components of vehicle 100.

As shown in FIG. 3, the vehicle system architecture 300 may comprise an engine, motor or propulsive device 302 and various sensors 304-318 for measuring various parameters of the vehicle system architecture 300. In gas-powered or hybrid vehicles having a fuel-powered engine, the sensors 304-318 may comprise, for example, an engine temperature sensor 304, a battery voltage sensor 306, an engine Rotations Per Minute (RPM) sensor 308, and/or a throttle position sensor 310. If the vehicle is an electric or hybrid vehicle, then the vehicle may comprise an electric motor, and accordingly may comprise sensors such as a battery monitoring system 312 (to measure current, voltage and/or temperature of the battery), motor current 314 and voltage 316 sensors, and motor position sensors such as resolvers and encoders 318.

Operational parameter sensors that are common to both types of vehicles may comprise, for example: a position sensor 334 such as an accelerometer, gyroscope and/or inertial measurement unit; a speed sensor 336; and/or an odometer sensor 338. The vehicle system architecture 300 also may comprise a clock 342 that the system uses to determine vehicle time and/or date during operation. The clock 342 may be encoded into the vehicle on-board computing device 320, it may be a separate device, or multiple clocks may be available.

The vehicle system architecture 300 may comprise various sensors that operate to gather information about the environment in which the vehicle is traveling. These sensors may comprise, for example: a location sensor 344 (for example, a Global Positioning System (GPS) device); object detection sensors such as one or more cameras 346; a LiDAR sensor system 348; and/or a radar and/or a sonar system 350. The sensors may comprise environmental sensors 352 such as, e.g., a humidity sensor, a precipitation sensor, a light sensor, and/or ambient temperature sensor. The object detection sensors may be configured to enable the vehicle system architecture 300 to detect objects that are within a given distance range of the vehicle in any direction, while the environmental sensors 352 may be configured to collect data about environmental conditions within the vehicle's area of travel. According to an exemplary embodiment, the vehicle system architecture 300 may comprise one or more lights 354 (e.g., headlights, flood lights, flashlights, etc.).

During operations, information may be communicated from the sensors to an on-board computing device 320 (e.g., computing device 125, computing device 400). The on-board computing device 320 may be configured to analyze the data captured by the sensors and/or data received from data providers and may be configured to optionally control operations of the vehicle system architecture 300 based on results of the analysis. For example, the on-board computing device 320 may be configured to control: braking via a brake controller 322; direction via a steering controller 324; speed and acceleration via a throttle controller 326 (in a gas-powered vehicle) or a motor speed controller 328 (such as a current level controller in an electric vehicle); a differential gear controller 330 (in vehicles with transmissions); and/or other controllers. The brake controller 322 may comprise a pedal effort sensor, pedal effort sensor, and/or simulator temperature sensor, as described herein. According to an exemplary embodiment, the computing device 320 may be configured to perform data analysis using artificial intelligence, machine learning, and/or other suitable means.

Geographic location information may be communicated from the location sensor 344 to the on-board computing device 320, which may then access a map of the environment that corresponds to the location information to determine known fixed features of the environment such as streets, buildings, stop signs and/or stop/go signals. Captured images from the cameras 346 and/or object detection information captured from sensors such as LiDAR 348 may be communicated from those sensors to the on-board computing device 320. The object detection information and/or captured images may be processed by the on-board computing device 320 to detect objects in proximity to the vehicle. Any known or to be known technique for making an object detection based on sensor data and/or captured images may be used in the embodiments disclosed in this document.

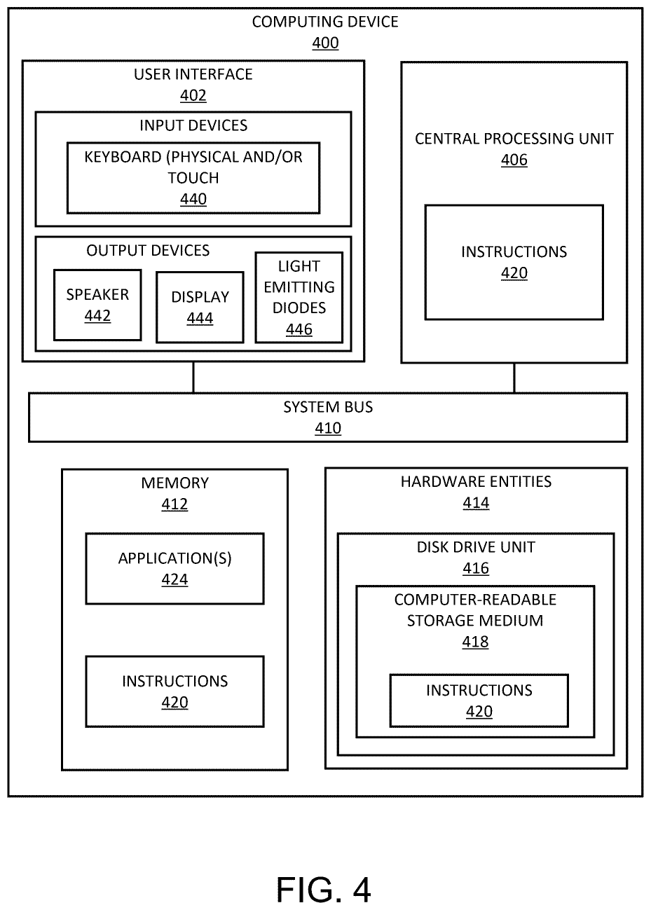

Referring now to FIG. 4, an illustration of an example architecture for a computing device 400 is provided. According to an exemplary embodiment, one or more functions of the present disclosure may be implemented by a computing device such as, e.g., computing device 400 or a computing device similar to computing device 400. Computing device 400 may be a quantum computer, a classical computer, and/or have one or more components configured to perform one or more quantum and/or classical computing functions. Computing device 125 and/or computing device 320 may be an example of computing device 400 and/or may comprise one or more components of computing device 400.

The hardware architecture of FIG. 4 represents one example implementation of a representative computing device configured to implement at least a portion of the systems/devices (e.g., vehicle 100) and method(s)/control logic(s) (e.g., method 200) described herein.

Some or all components of the computing device 400 may be implemented as hardware, software, and/or a combination of hardware and software. The hardware may comprise, but is not limited to, one or more electronic circuits. The electronic circuits may comprise, but are not limited to, passive components (e.g., resistors and capacitors) and/or active components (e.g., amplifiers and/or microprocessors). The passive and/or active components may be adapted to, arranged to, and/or programmed to perform one or more of the methodologies, procedures, or functions described herein.

As shown in FIG. 4, the computing device 400 may comprise a user interface 402 (e.g., a graphical user interface), a Central Processing Unit (“CPU”) 406, a system bus 410, a memory 412 connected to and accessible by other portions of computing device 400 through system bus 410, and hardware entities 414 connected to system bus 410. The user interface may comprise input devices and output devices, which may be configured to facilitate user-software interactions for controlling operations of the computing device 400. The input devices may comprise, but are not limited to, a physical and/or touch keyboard 440. The input devices may be connected to the computing device 400 via a wired or wireless connection (e.g., a Bluetooth® connection). The output devices may comprise, but are not limited to, a speaker 442, a display 444, and/or light emitting diodes 446.

At least some of the hardware entities 414 may be configured to perform actions involving access to and use of memory 412, which may be a Random Access Memory (RAM), a disk driver and/or a Compact Disc Read Only Memory (CD-ROM), among other suitable memory types. Hardware entities 414 may comprise a disk drive unit 416 comprising a computer-readable storage medium 418 on which may be stored one or more sets of instructions 420 (e.g., programming instructions such as, but not limited to, software code) configured to implement one or more of the methodologies, procedures, or functions described herein. The instructions 420 may also reside, completely or at least partially, within the memory 412 and/or within the CPU 406 during execution thereof by the computing device 400.

The memory 412 and the CPU 406 may also constitute machine-readable media. The term “machine-readable media”, as used here, refers to a single medium or multiple media (e.g., a centralized or distributed database, and/or associated caches and servers) that store the one or more sets of instructions 420. The term “machine-readable media”, as used here, also refers to any medium that is capable of storing, encoding, or carrying a set of instructions 420 for execution by the computing device 400 and that cause the computing device 400 to perform any one or more of the methodologies of the present disclosure. According to various embodiments, one or more computer applications 424 may be stored on the memory 412.

What has been described above includes examples of the subject disclosure. It is, of course, not possible to describe every conceivable combination of components or methodologies for purposes of describing the subject matter, but it is to be appreciated that many further combinations and permutations of the subject disclosure are possible. Accordingly, the claimed subject matter is intended to embrace all such alterations, modifications, and variations that fall within the spirit and scope of the appended claims.

In particular and in regard to the various functions performed by the above described components, devices, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter.

The aforementioned systems and components have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components. Any components described herein may also interact with one or more other components not specifically described herein.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

Thus, the embodiments and examples set forth herein were presented in order to best explain various selected embodiments of the present invention and its particular application and to thereby enable those skilled in the art to make and use embodiments of the invention. However, those skilled in the art will recognize that the foregoing description and examples have been presented for the purposes of illustration and example only. The description as set forth is not intended to be exhaustive or to limit the embodiments of the invention to the precise form disclosed.

What is claimed is:

1. A system for predicting windshield wiper wear, comprising:
a vehicle comprising a windshield wiper,
wherein the windshield wiper comprises a windshield wiper blade;
one or more environmental sensors configured to generate environmental data of an environment of the vehicle; and
a computing device comprising:
a processor; and
a memory,
wherein the memory is configured to store instructions that, when executed by the processor, are configured to cause the processor to:
receive the environmental data from the one or more environmental sensors; and
calculate wear of the windshield wiper blade based on the environmental data.

2. The system of claim 1, wherein the instructions, when executed by the processor, are further configured to cause the processor to determine a usage of the windshield wiper comprising a length of time the windshield wiper was in an on state over a set timeframe.

3. The system of claim 2, wherein the instructions, when executed by the processor, are further configured to cause the processor to:
adjust the wear of the windshield wiper blade due to the usage of the windshield wiper, generating an adjusted wear of the windshield wiper blade;
determine whether the adjusted wear of the windshield wiper blade is greater than a threshold wear; and
when the adjusted wear of the windshield wiper blade is greater than the threshold wear, generate a warning alert.

4. The system of claim 3, wherein the adjusting the wear of the windshield wiper blade comprises:
determining a windshield wiper blade use factor; and
multiplying the wear of the windshield wiper blade by the windshield wiper blade user factor.

5. The system of claim 3, wherein:
the computing device further comprises a graphical user interface;
the instructions, when executed by the processor, are further configured to cause the processor to play the warning alert on the graphical user interface; and
the warning alert comprises an audio and/or visual alert.

6. The system of claim 1, wherein the one or more environmental sensors comprise one or more of:
a temperature sensor;
a rainfall sensor; and
a solar load sensor.

7. The system of claim 6, wherein the temperature sensor is configured to:
measure an outside air temperature; and
collect data to be used to estimate one or more heat cycles the windshield wiper blades.

8. The system of claim 6, wherein the rainfall sensor is configured to collect data to be used to estimate how much rain the windshield wiper blades have been exposed to.

9. The system of claim 6, wherein the solar load sensor is configured to collect data to be used to determine how much sunlight the windshield wiper blades have been exposed to.

10. The system of claim 1, wherein the vehicle comprises an autonomous vehicle.

11. A method for predicting windshield wiper wear, comprising:
generating, using one or more environmental sensors, environmental data of an environment of a vehicle,
wherein:
the vehicle comprises a windshield wiper, and
the windshield wiper comprises a windshield wiper blade; and
using a computing device:
receiving the environmental data from the one or more environmental sensors; and
calculating wear of the windshield wiper blade based on the environmental data,
wherein the computing device comprises:
a processor; and
a memory.

12. The method of claim 11, further comprising, using the computing device, determining a usage of the windshield wiper comprising a length of time the windshield wiper was in an on state over a set timeframe.

13. The method of claim 12, further comprising:
adjusting the wear of the windshield wiper blade due to the usage of the windshield wiper, generating an adjusted wear of the windshield wiper blade;
determining whether the adjusted wear of the windshield wiper blade is greater than a threshold wear; and
when the adjusted wear of the windshield wiper blade is greater than the threshold wear, generating a warning alert.

14. The method of claim 13, wherein the adjusting the wear of the windshield wiper blade comprises:
determining a windshield wiper blade use factor; and
multiplying the wear of the windshield wiper blade by the windshield wiper blade user factor.

15. The method of claim 13, further comprising, using the computing device, causing the processor to play the warning alert on a graphical user interface,
wherein:
the computing device further comprises the graphical user interface; and
the warning alert comprises an audio and/or visual alert.

16. The method of claim 11, wherein the one or more environmental sensors comprise one or more of:
a temperature sensor;
a rainfall sensor; and
a solar load sensor.

17. The method of claim 16, wherein the temperature sensor is configured to:
measure an outside air temperature; and
collect data to be used to estimate one or more heat cycles the windshield wiper blades.

18. The method of claim 16, wherein the rainfall sensor is configured to collect data to be used to estimate how much rain the windshield wiper blades have been exposed to.

19. The method of claim 16, wherein the solar load sensor is configured to collect data to be used to determine how much sunlight the windshield wiper blades have been exposed to.

20. The method of claim 11, wherein the vehicle comprises an autonomous vehicle.
